(19) United States
(12) Patent Application Publication
(10) Pub. No.: US 2015/0180117 A1
(43) Pub. Date: Jun. 25, 2015

(54) INVERTED-F ANTENNA PROVIDED WITH AN ISOLATION UNIT

(71) Applicant: Taiwan Tongda Communication Co., Ltd., Kaohsiung City (TW)

(72) Inventor: Wei-Hung RUAN, Kaohsiung City (TW)

(73) Assignee: Taiwan Tongda Communication Co., Ltd., Kaohsiung City (TW)

(21) Appl. No.: 14/272,137

(22) Filed: May 7, 2014

(30) Foreign Application Priority Data
Dec. 19, 2013 (TW) 102223983

(51) Int. Cl. H01Q 1/52; H01Q 9/04

(52) U.S. Cl. CPC H01Q 1/526; H01Q 9/0421

(57) ABSTRACT

An inverted-F antenna includes a ground unit, a radiating unit, a short circuit unit, and an isolation unit. The radiating unit is spaced apart from the ground unit, and includes a feed-in point that is configured to be fed with a radio frequency signal. The short circuit unit is coupled between the ground unit and the radiating unit. The isolation unit is spaced apart from the ground unit and the radiating unit, is coupled to the short circuit unit, and includes a portion that is adjacent to the radiating unit and that projectively overlaps a portion of the radiating unit in a direction toward the ground unit.

### CROSS-REFERENCE TO RELATED APPLICATION

This application claims priority of Taiwanese Application No. 102223983, filed on Dec. 19, 2013.

### BACKGROUND OF THE INVENTION

1. Field of the Invention

The present invention relates to an antenna, more particularly to an inverted-F antenna.

2. Description of the Related Art

Referring to FIG. 1, a conventional inverted-F antenna configured to be disposed in a laptop computer (not shown) for transceiving radio waves is shown to include a ground element 11, a T-shaped radiating element 12 that is spaced apart from the ground element 11 and that has a feed-in point 121 for transceiving radio frequency signals, and a short circuit element 13 that is substantially L-shaped and that has opposite end parts coupled respectively to the ground element 11 and the radiating element 12.

In general, a laptop computer is provided with two of the conventional inverted-F antennas, one of which serves as a main antenna and the other one of which serves as an auxiliary antenna that operates to assist in transceiving the radio frequency signals when the main antenna has poor performance.

Referring further to FIG. 2, S-parameters (S11) of the main antenna and S-parameters (S22) of the auxiliary antenna are shown to indicate that both of the main antenna and the auxiliary antenna resonate in a frequency band ranging from 2.4 GHz to 2.5 GHz. Isolation between the main antenna and the auxiliary antenna is indicated by parameters (S12), and is shown to be −20.393 dB, −19.812 dB and −20.145 dB at frequencies of 2.4 GHz, 2.45 GHz and 2.5 GHz, respectively. It is evident that the conventional inverted-F antennas disposed in a small size electronic device may easily interfere with each other. Thus, the isolation between the conventional inverted-F antennas at the resonant frequency band thereof needs improvement.

### SUMMARY OF THE INVENTION

Therefore, an object of the present invention is to provide an inverted-F antenna that may alleviate the above drawbacks of the prior art.

Accordingly, an inverted-F antenna of the present invention includes a ground unit, a radiating unit, a short circuit unit and an isolation unit.

The radiating unit is spaced apart from the ground unit and includes a feed-in point that is configured to be fed with a radio frequency signal. The short circuit unit is coupled between the ground unit and the radiating unit. The isolation unit is spaced apart from the ground unit and the radiating unit, is coupled to the short circuit unit, and includes a portion that is adjacent to the radiating unit and that projectively overlaps a portion of the radiating unit in a direction toward the ground unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional inverted-F antenna;

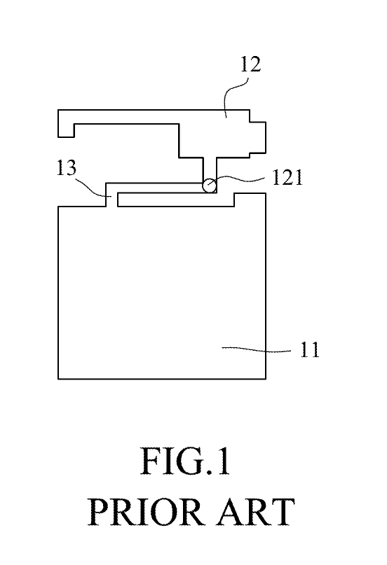

FIG. 2 is a plot showing S-parameters of two of the conventional inverted-F antennas and isolation therebetween;

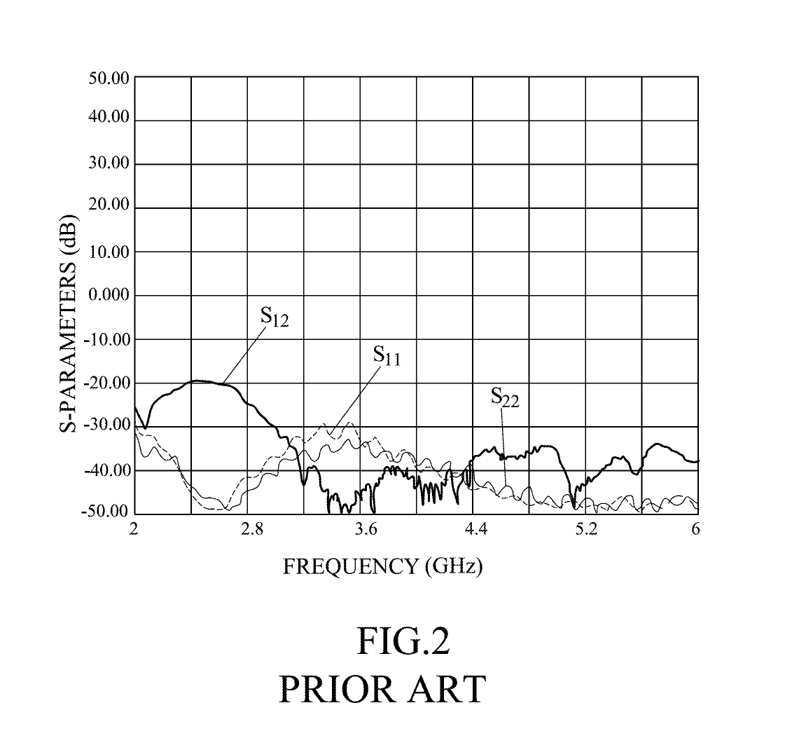

FIG. 3 is a schematic view of a preferred embodiment of an inverted-F antenna provided with an isolation unit according to the present invention;

FIG. 4 is a schematic view for illustrating arrangement of two of the inverted-F antennas of the preferred embodiment according to the present invention; and

FIG. 5 is a plot showing S-parameters of the inverted-F antennas of the preferred embodiment and isolation therebetween according to the present invention.

### DETAILED DESCRIPTION OF THE PREFERRED EMBODIMENT

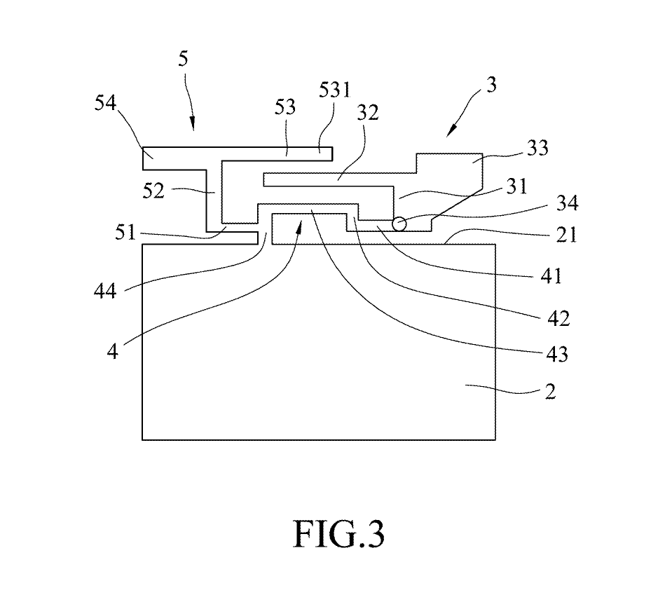

Referring to FIG. 3, a preferred embodiment of an inverted-F antenna of the present invention includes a ground unit 2, a radiating unit 3 for transceiving radio frequency signals, a short circuit unit 4 for extending an electrical length of the radiating unit 3, and an isolation unit 5 for improving isolation of the inverted-F antenna at a resonant frequency band.

In this preferred embodiment, the ground unit 2 is substantially rectangular in shape. The radiating unit 3, the short circuit unit 4 and the isolation unit 5 are coplanar, and are disposed at the same side (i.e., a connecting side 21) of the ground unit 2. The radiating unit 3 is spaced apart from the connecting side 21 of the ground unit 2. The short circuit unit 4 has opposite ends coupled respectively to the connecting side 21 of the ground unit 2 and the radiating unit 3. The isolation unit 5 is spaced apart from the connecting side 21 of the ground unit 2 and the radiating unit 3, and is coupled to the short circuit unit 4.

In this preferred embodiment, the radiating unit 3 includes a connecting arm 31, a first radiating arm 32, a second radiating arm 33 and a feed-in point 34. The connecting arm 31 is substantially rectangular in shape, extends from the short circuit unit 4 in a direction away from the ground unit 2, and is substantially perpendicular to the connecting side 21 of the ground unit 2. The first radiating arm 32 is substantially=rectangular in shape, extends toward the isolation unit 5 from one longitudinal side of the connecting arm 31 that is away from the ground unit 2, and is substantially parallel to the connecting side 21 of the ground unit 2. The second radiating arm 33 is substantially trapezoidal in shape, and extends in a direction away from the first radiating arm 32 from the other longitudinal side of the connecting arm 31 that is opposite to the first radiating arm 32. The second radiating arm 33 has two parallel sides, one of which is partially connected to the connecting arm 31 and partially extends beyond the connecting arm 31 in the direction away from the ground unit 2. The feed-in point 34 is disposed at an end part of the connecting arm 31 that is coupled to the short circuit unit 4, and is configured to be fed with a radio frequency signal.

In this preferred embodiment, the short circuit unit 4 includes a feed-in segment 41, a first extending segment 42, a second extending segment 43 and a short circuit segment 44. The feed-in segment 41 is substantially rectangular in shape, extends from the connecting arm 31 toward the isolation unit 5, and is substantially parallel to the connecting side 21 of the ground unit 2. The first extending segment 42 is substantially rectangular in shape, extends in the direction away from the ground unit 2 from one end of the feed-in segment 41 that is close to the isolation unit 5, and is substantially perpendicular to the connecting side 21 of the ground unit 2. The second extending segment 43 is substantially rectangular in shape, extends toward the isolation unit 5 from one end of the first extending segment 42 that is away from the ground unit 2, and is substantially parallel to the connecting side 21 of the ground unit 2. The short circuit segment 44 is substantially rectangular in shape, extends toward the ground unit 2 from one end of the second extending segment 43 that is close to the isolation unit 5, and is coupled to the ground unit 2.

In this preferred embodiment, the isolation unit 5 includes a coupling arm 51, an extending arm 52, an isolation arm 53 and an impedance-matching arm 54. The coupling arm. 51 is substantially rectangular in shape, extends away from the radiating unit 3 from one side of the short circuit segment 44 that is opposite to the second extending segment 43, and is substantially parallel to the connecting side 21 of the ground unit 2. The extending arm 52 is substantially rectangular in shape, extends in the direction away from the ground unit 2 from one end of the coupling arm 51 that is away from the radiating unit 3, and is substantially perpendicular to the connecting side 21 of the ground unit 2. The isolation arm 53 is substantially rectangular in shape, extends toward the radiating unit 3 from one end of the extending arm 52 that is away from the ground unit 2, and is substantially parallel to the connecting side 21 of the ground unit 2. The isolation arm 53 has an end portion 531 that is away from the extending arm 52 and that projectively overlaps a portion of the first radiating arm 32 of the radiating unit 3 in a direction toward the ground unit 2. The impedance-matching arm 54 is substantially rectangular in shape, extends in the direction away from the radiating unit 3 from said one end of the extending arm 52 that is away from the ground unit 2, and is substantially parallel to the connecting side 21 of the ground unit 2.

When the radiating unit 3 transmits/receives radio frequency signals via the feed-in point 34 thereof, an electrical length of combination of the connecting arm 31 and the first radiating arm 32 results in a first resonant frequency band, and an electrical length of combination of the connecting arm 31 and the second radiating arm 33 results in a second resonant frequency band. By virtue of the coupling arm 51 disposed close to and coupling with the ground unit 2 and the end portion 531 of the isolation arm 53 projectively overlapping and coupling with the portion of the first radiating arm 32, the isolation of the first radiating arm 32 at the first resonant frequency band may be improved. Therefore, the isolation arm 53 and the coupling arm 51 cooperate to improve the isolation of the first radiating arm 32 at the first resonant frequency band so as to alleviate interference among neighboring antennas. Moreover, the impedance-matching arm 54 is configured for matching impedance of the isolation arm 53 and the first radiating arm 32 so as to further improve the isolation of the first radiating arm 32 at the first resonant frequency band.

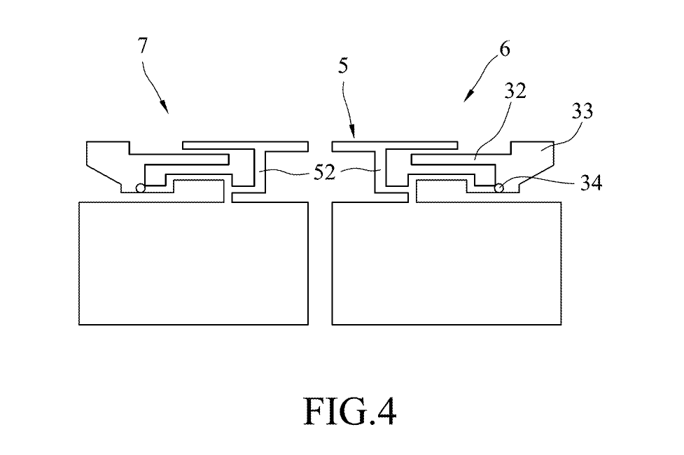

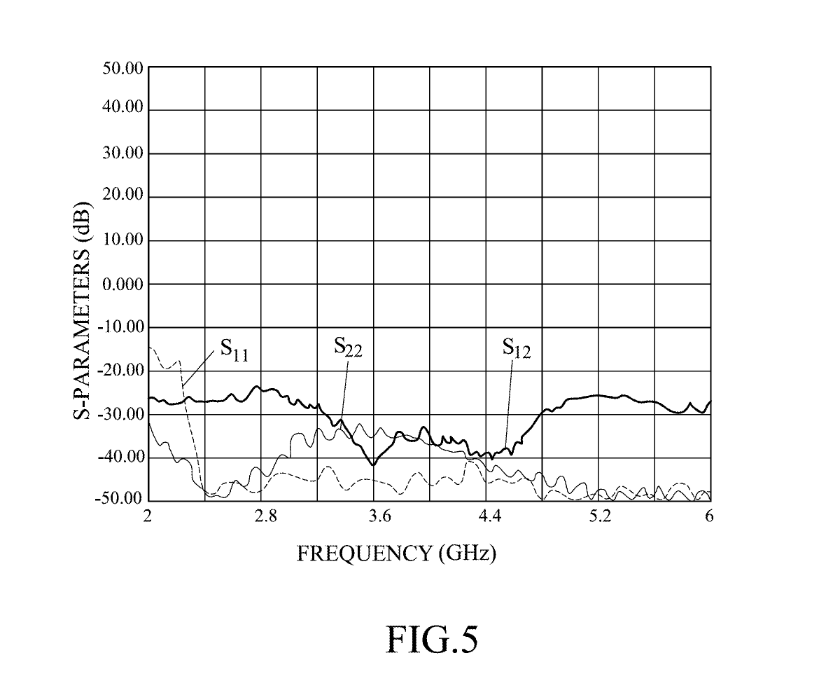

Referring to FIG. 4, two of the inverted-F antennas of the preferred embodiment according to the present invention are shown to be symmetrical to each other. One of the inverted-F antennas serves as a main antenna 6, and the other one serves as an auxiliary antenna 7 which operates to assist in transceiving radio frequency signals when the main antenna 6 has poor performance. The extending arms 52 respectively of the main antenna 6 and the auxiliary antenna 7 are disposed to face each other. Referring further to FIG. 5, S-parameters (S11) of the main antenna 6, S-parameters (S22) of the auxiliary antenna 7, and isolation (S12) between the main antenna 6 and the auxiliary antenna 7 are shown. S-parameters (S11) of the main antenna 6 are measured at the feed-in point 34 of the main antenna 6. A resonant frequency band of the first radiating arm 32 of the main antenna 6 ranges from 2.45 GHz to 2.5 GHz. A resonant frequency band of the second radiating arm 33 of the main antenna 6 ranges from 5.1 GHz to 5.8 GHz. The isolation (S12) between the main antenna 6 and the auxiliary antenna 7 is −26.386 dB, −26.448 dB and −26.808 dB at frequencies of 2.4 GHz, 2.45 GHz and 2.5 GHz, respectively. Therefore, by virtue of the isolation unit 5 of the inverted-F antenna of the present invention, the isolation (S12) between two inverted-F antennas 6, 7 at the resonant frequency band of the first radiating arm 32, may be effectively improved.

It is understood that the impedance-matching arm 54 is for matching impedance of the isolation arm 53 and the first radiating arm 32 by adjusting the length of the impedance-matching arm 54. Therefore, if the impedance matching of the isolation arm 53 and the first radiating arm 32 is ideal and does not need adjustment, the impedance-matching arm 54 may be omitted.

To conclude, according to the present invention, the coupling arm 51 couples with the ground unit 2 via the short circuit arm 44, the isolation arm 53 couples with the first radiating arm 32, and the impedance-matching arm 54 matches impedance. As a result, the isolation between two of the inverted-F antennas at the resonant frequency band of the first radiating arm 32 may be significantly improved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An inverted-F antenna comprising:
a ground unit;
a radiating unit spaced apart from said ground unit and including a feed-in point that is configured to be fed with a radio frequency signal;
a short circuit unit coupled between said ground unit and said radiating unit; and
an isolation unit spaced apart from said ground unit and said radiating unit, coupled to said short circuit unit, and including a portion that is adjacent to said radiating unit and that projectively overlaps a portion of said radiating unit in a direction toward said ground unit.

2. The inverted-F antenna as claimed in claim 1, wherein said isolation unit is coupled to said short circuit unit opposite to said radiating unit, and further includes a coupling arm extending from said short circuit unit away from said radiating unit, an extending arm extending from said coupling arm away from said ground unit, and an isolation arm extending from said extending arm toward said radiating unit and having an end portion that serves as said portion of said isolation unit.

3. The inverted-F antenna as claimed in claim 2, wherein said isolation unit further includes an impedance-matching arm extending from said extending arm away from said radiating unit.

4. The inverted-F antenna as claimed in claim 1, wherein said radiating unit further includes a connecting arm extending from said short circuit unit away from said ground unit, and a first radiating arm extending from said connecting arm toward said isolation unit,
wherein said feed-in point is disposed at an end part of said connecting arm that is coupled to said short circuit unit.

5. The inverted-F antenna as claimed in claim 4, wherein said radiating unit further includes a second radiating arm extending from said connecting arm away from said first radiating arm.

6. The inverted-F antenna as claimed in claim 1, wherein said short circuit unit includes a feed-in segment extending from said radiating unit toward said isolation unit, a first extending segment extending from said feed-in segment away from said ground unit, a second extending segment extending from said first extending segment toward said isolation unit, and a short circuit segment extending from said second extending segment toward said ground unit to couple thereto.

7. The inverted-F antenna as claimed in claim 6, wherein said isolation unit is coupled to said short circuit segment of said short circuit unit.
